(19) United States
(12) Patent Application Publication
(10) Pub. No.: US 2020/0375223 A1
(43) Pub. Date: Dec. 3, 2020

(54) SHELF-STABILIZED CHLOROPHYLL WATER

(71) Applicant: Chlorophyll Water, LLC, Brooklyn, NY (US)

(72) Inventor: Matthew Levine, Boca Raton, FL (US)

(73) Assignee: Chlorophyll Water, LLC, Boca Raton, FL (US)

(21) Appl. No.: 16/891,036

(22) Filed: Jun. 2, 2020

Related U.S. Application Data
(60) Provisional application No. 62/856,669, filed on Jun. 3, 2019.
(60) Provisional application No. 62/856,675, filed on Jun. 3, 2019.
(60) Provisional application No. 62/856,681, filed on Jun. 3, 2019.
(60) Provisional application No. 62/856,685, filed on Jun. 3, 2019.

(51) Int. Cl. A23L 2/56; A23L 2/44; A23L 33/00; A23L 33/155; A23L 33/105; A23L 2/72; A23L 2/02

(52) U.S. Cl. CPC A23L 2/56; A23L 2/44; A23L 33/30; A23L 2/02; A23L 33/105; A23L 2/72; A23L 33/155

(57) ABSTRACT

Described herein is a system a method and composition for manufacturing shelf-stabilized chlorophyll in beverage form. The chlorophyll beverage may be produced on a commercial or larger scale. The chlorophyll beverage may be formed of chlorophyllin and water, as well as a shelf-stabilization agent, with no refrigeration required.

### BACKGROUND

Current trends in human wellness and health have encouraged healthy eating and drinking, and an overall awareness and focus on diet. In particular, there is a focus on products that provide multiple benefits.

One such product is chlorophyll. Chlorophyll is a green pigment that is found in plants and vegetables, and is used by plants to provide its nutrition, Chlorophyll has also been shown to provide a myriad of benefits to humans, including stimulating the immune system, detoxifying the human body (“cleansing”), preventing cancer, reducing inflammation, weight loss, and providing a sustained boost of energy.

The use and benefits of chlorophyll as a supplement have been well documented. Indeed, chlorophyll is available in many forms, such as caplets, tablets, concentrates, powders, ointments, sprays and liquid concentrate.

While beverages based on, or formed substantially of, liquid chlorophyll concentrate are in high demand, the composition of chlorophyll is notoriously fickle, and cannot remain shelf stable for an extended period of time after diluted for human consumption. Thus, liquid chlorophyll concentrate, as currently available, is not available in a shelf-stabilized form when mixed with water, and must therefore be made at home or in small batches, and for near-immediate consumption.

Current production of enhanced waters is limited to techniques known as “hot-fill” processing or manufacturing, and high-pressure processing. Further, certain manufacturers utilize juice concentrates, such as watermelon or cucumber juice, to reduce pH levels. These manufacturing methods reduce the efficacy of the chlorophyll extract. Moreover, such methods require large machinery, as well as certain specific types of bulky, ribbed water bottles to be utilized.

Additionally, hot-fill processes require injecting hot liquid into a container, inverting the container, and allowing the liquid, which is between 194-203 degrees Fahrenheit, to sterilize the container and cap. The heat treatment often lasts between 15-20 seconds. This requires a certain type of container, which does not change form at high temperatures, often referred to as heat set bottles. Such heat set bottles are custom made, and are formed to be heavier in the head and neck of the body, in order to withstand the heat, with a heavier cap.

It would be desirable, therefore, to provide a method and composition for manufacturing shelf-stabilized chlorophyll in beverage form. It would be further desirable to provide a form of chlorophyll beverage that can be produced on a commercial or larger scale, in order to allow chlorophyll beverages to be more widely distributed and their benefits spread to those who do not have access to small-batch manufacturing of chlorophyll beverage.

Thus, a method and composition for manufacturing shelf-stabilized chlorophyll in a beverage is hereby provided.

### DESCRIPTION OF THE DRAWINGS

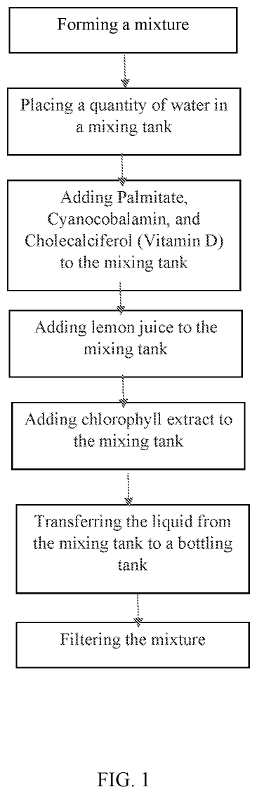

In the drawings, FIG. 1 shows an exemplary process in accordance with an embodiment of the invention.

### DETAILED DESCRIPTION OF THE INVENTION

As disclosed herein, the chlorophyll beverage is formed of a chlorophyll extract, also known as chlorophyllin, and beverage base, such as water, or any other suitable beverage base. As referred to herein, chlorophyll beverage may include chlorophyll water.

In one embodiment, the chlorophyll beverage may be formed of chlorophyllin and water. The water may include any type of water, including sparkling or flavored waters. The chlorophyllin may be copper chlorophyllin. The chlorophyll beverage may further include a shelf-stabilization agent. In another embodiment, the chlorophyll beverage may be formed in shelf-stabilized form, with no refrigeration required, of copper chlorophyllin, water, and vitamins. An exemplary shelf-stabilized formulation of chlorophyll beverage, allowing for mass-manufacturing and shelf life in excess of at least six months, may include (1) a quantity of water; (2) a quantity of copper chlorophyllin; and (3) a quantity of dimethyl dicarbonate (DMDC), as well as vitamins and flavoring as desired. :In another embodiment, an exemplary shelf-stabilized formulation of chlorophyll beverage, allowing for mass-manufacturing and shelf life in excess of at least six months may include (1) a quantity of water; (2) a quantity of copper chlorophyllin; and (3) a quantity of Natural Plant Extractives, as well as vitamins and flavoring as desired.

In accordance with certain embodiments, the composition does not include a heat or high-pressure step, instead being treated with dimethyl dicarbonate, which is an anti-microbial. The dimethyl dicarbonate provides for shelf-stabilization, by reducing or eliminating any microbials that would otherwise form. In an embodiment, the dimethyl dicarbonate is applied to each bottle of chlorophyll beverage at a concentration of 238 mg/L. In another embodiment, the dimethyl dicarbonate may be applied at a concentration of between 225-255 mg/L. This range specifically provides for antimicrobial reduction and increased shelf-stability. After the addition of the dimethyl dicarbonate, the bottle of chlorophyll beverage is then sealed.

In another embodiment, Natural Plant Extractives, may be used in place of a heat or high-pressure step. Exemplary Natural Plant Extractives (also referred to as “NPEs”) include, but are not limited to, dandelion root extract, rosemary extract, lavender extract, aloe vera extract, celery root extract, green tea leaf extract, peppermint leaf extract, valerian root extract, pine bark extract, grape seed extract, perilla leaf extract, apple extract, apple cider extract or any other suitable Natural Plant Extractive. In another embodiment, the Natural Plant Extractives may be composed of organic MicroFresh® (a registered trademark of MicroFresh International, referred to herein is as “MicroFresh”), which is an anti-microbial, may be used in place of a heat or high-pressure step. Natural Plant Extractives provide for shelf-stabilization, by reducing or eliminating any microbials that would otherwise form. Natural Plant Extractives, including MicroFresh, are specifically designed to replace artificial preservatives such as benzoates, sorbates, BHA and BHT. NPEs are organic, and naturally protects the beverage from harmful, bacteria and mold. In an embodiment, NPEs or MicroFresh are applied to each bottle of chlorophyll beverage at >0.2%. This range specifically provides for antimicrobial reduction and increased shelf-stability.

NPEs provide for an organic, self-preservation component for the beverage, a very powerful broad-spectrum antimicrobial activity. NPEs protect and extend product quality and shelf-life by creating synergistic reaction of bioflavonoids, flavor components, polyphenols and other organic acids that are effective against gram-positive and gram-negative bacteria, fungi, molds and yeast.

The addition of NPEs reduce or eliminate the need for heat pasteurization, or hot-fill or high-pressure filling of beverage bottles. For example, the addition of >0.2% NPE may inactivate e. coil, salmonella and other bacteria. This allows for room-temperature beverages to remain shelf-stable without worry of bacterial growth.

In an embodiment, dimethyl &carbonate is specifically formulated, and utilized to increase microbiological efficacy against foodborne bacterial pathogens, yeasts and molds associated with beverages. Exemplary indications of this effect is shown in “Antimicrobials in food,” Golden, D. A., Worobo, R. W. and Ough, C. S., 2005, 10 Dimethyl Dicarbonate and Diethyl Dicarbonate, the contents of which are incorporated by reference in its entirety.

Thus, the addition of DMDC may reduce or eliminate the need for heat pasteurization, or hot-fill or high-pressure filling of beverage bottles. For example, the addition of 220-270 ppm DNIDC may inactivate e. coli, salmonella and other bacteria. This allows for room-temperature beverages to remain shelf-stable without worry of bacterial growth,

In accordance with an embodiment, DMDC may provide inhibitory activities against microorganisms and other bacteria. In an embodiment, DMDC, when added to a chlorophyll beverage, quickly breaks down into microscopic particles of methanol and carbon dioxide. The DMDC thus penetrates cells of bacteria and mold, deactivating their principal cells. DMDC does not affect the taste of the chlorophyll beverage, and does not impart a smell or color. Further, DMDC may remain active for several hours, thereby eliminating contamination from other sources such as bottles, closures and filling equipment. It should be noted that DMDC, as disclosed herein, degrades within 24 hours of placement within the bottle, but provides the chlorophyll beverage with shelf stability for in excess of 6 months.

In an embodiment, the formulation for a shelf-stabilized form of the chlorophyll beverage may include the following proportional quantities. The example illustrated below shows the preferred proportions of ingredients, but may be adjusted proportionally for any suitable volume. Thus, in an exemplary formulation based on a total volume of 1,000 gallons, there is 1.974 pounds of copper chlorophyllin. This amount, after research, has been shown to provide the optimal amount of chlorophyll for human consumption. In another embodiment, 1.8-2.0 pounds of copper chlorophyllin may be used for a total volume of 1,000 gallons. In yet another embodiment, 0.3-6 pounds of chlorophyll may be used.

The formulation may further include 0.01 pounds of premixed vitamins A, B12 and D, per 1,000 gallons. In another embodiment, the formulation may include 0.005-0.05 pounds of premixed vitamins. The formulation may further include 1.67 pounds of lemon juice, and/or 1.25 pounds of natural spearmint per 1,000 gallons. In another embodiment, the formulation may include 1.5-1.8 pounds of lemon juice and 1.1-1.4 pounds of natural spearmint.

Exemplary formulations of shelf-stabilized chlorophyll may be one of the following:

a. Copper chlorophyllin+water+NPEs;

b. Copper chlorophyllin+water+DMDC; or

c. Copper chlorophyllin+water+NPEs+DMDC.

The vitamins may be formed of one or more of Palmitate (Vitamin A), Cyanocobalamin (Vitamin B12), and Cholecalciferol (Vitamin D). It should be noted that some or all of the vitamins may be used in this embodiment.

The formulation may further include 0.01 pounds of premixed Vitamins A, B12 and D, per 1,000 gallons. In another embodiment, the formulation may include 0.005-0.05 pounds of premixed vitamins.

As disclosed, the vitamins may be specifically formed and provided to provide very specific health benefits. For example, the unique combination of Vitamins A, B12 and D, in the ratios and/or weights provided allows for energy boost, immunity and immune system health, cell creation, improved mood, relief for symptoms of depression, increased antioxidants, improved functioning of white blood cells, preventing iron deficiencies, improved memory, improved heart health, red blood cell formation, anemia prevention, bone health, osteoporosis prevention, and healthy hair, skin, and nails.

In yet another embodiment, the chlorophyll beverage may be formed in shelf-stabilized form, with no refrigeration required, from a combination of copper chlorophyllin, lemon juice (which provides increased Vitamin C absorption and flavor profile), mint and Vitamins A, B, and D. The use of mint was specifically selected for its stimulant properties, which provides increased brain functioning and energy. In an embodiment, the use of mint with a chlorophyll liquid concentrate is specially formed to provide enhanced taste, while also symbiotically harnessing the brain stimulation of chlorophyll and mint to exponentially increase energy levels and brain functioning. In an embodiment, the specific combination of these ingredients is specifically formed to create a uniformly distributed chlorophyll beverage. Thus, the chlorophyll particles are evenly distributed, reducing or preventing settling of chlorophyll within the beverage or to the bottom of the beverage.

In another embodiment, the chlorophyll beverage may be formed in a shelf-stabilize form using specifically purified water in combination with copper chlorophyllin, natural plant extracts, lemon juice (such as organic lemon juice), natural spearmint, and Vitamins A, B and D. In an embodiment, the purified water is purified to a level to prevent latching of microorganisms and bacterial growth. In a further embodiment, the natural plant extracts as disclosed herein provide shelf-stabilization. Specifically, lemon juice reduces the pH levels, which in turns makes the beverage inhospitable to growth of microorganisms. It should be noted that the purified water may be formed of Ultraviolet treated water, reverse osmosis water, or carbon filtered water. It should be further understood that the inventive combination as disclosed above is specifically formed to provide health benefits of chlorophyll, while increasing shelf-stabilization of the chlorophyll beverage.

The chlorophyll beverage is ideally formed such that it is shelf-stable and ambient temperature for human consumption.

In one embodiment, the beverage is formed of (1) water, 90%-99.9% by weight. In a further embodiment, the beverage is formed of 99.7%-99.8% water by weight. The beverage is further formed of a chlorophyllin liquid (such as copper chlorophyllin), of 0.02-0.03% by weight (or a similarly suitable amount, for example 0.01-0.5%), 0.01-0.03% natural mint flavor, 0.01-0.03% (or a similarly suitable amount, for example 0.01-0.5%) lemon juice, a vitamin mixture, and 0.1-0.4% (or a similarly suitable amount, for example 0.01-1%) of a shelf-stabilization agent.

In another embodiment, the beverage is formed of 99.74% water, 0.015% natural spearmint flavor, 0.0236% copper chlorophyllin liquid, 0.02% lemon juice, 0.0012% vitamin formulation, and 0.2% of the shelf stabilization agent.

In an embodiment, the process of manufacture may include one or more of the following steps:
(a) Place a quantity of water in a mixing tank;
(b) add Palmitate (Vitamin A), Cyanocobalamin (Vitamin B12), and Cholecalciferol (Vitamin D) to the mixing tank while mixing simultaneously;
(c) add lemon juice to the mixing tank;
(d) add chlorophyll extract to the mixing tank;
(e) add spearmint to the mixing tank;
(f) the entire mixture is transferred to a bottling tank with water;
(g) the mixture is filtered;
(h) after being filtered, the mixture enters the filler; and
(i) the mixture is then placed in a bottle and package.

In step (a), the water may be at a temperature of exactly 60 degrees Fahrenheit. In an embodiment, the temperature may be between 55-65 degrees Fahrenheit. In step (b), one or more of the vitamins may be added in various quantities, and mixed within the water. In step (d), the chlorophyll extract may be any suitable form. For example, copper chlorophyllin may be used. In step (e), the spearmint may be natural based, with no added materials. In (g), the mixture is filtered using a very fine filter, such as one that is 5 microns think or less. As illustrated, no heating of the beverage occurs prior to filling, thus not requiring a hot-fill process.

In accordance with the invention, the process allows the use of non-hot fill bottles, such as a sleek, non-ridged lightweight bottle. This does not require the use of a hot-filled water bottle.

Additionally, the disclosed process does not require the use of high-pressure processing, which applies pressure to fruits and vegetables placed whole within a bottle. However, high pressure processing requires the use of wider mouths and wider bottles.

In an embodiment, the specific combination of these ingredients is specifically formed to create a uniformly distributed chlorophyll beverage. Additional ingredients may be added as needed or desired, such as, for example, glycerin. Thus, the chlorophyll particles are evenly distributed, reducing or preventing settling of chlorophyll within the beverage or to the bottom of the beverage.

It should be noted that, due to the shelf-stabilization of the chlorophyll beverage, refrigeration is not required at any stage.

While this invention has been described in conjunction with the embodiments outlined above, many alternatives, modifications and variations will be apparent to those skilled in the art upon reading the foregoing disclosure. Accordingly, the embodiments of the invention, as set forth above, are intended to be illustrative, not limiting. Various changes may be made without departing from the spirit and scope of the invention.

What is claimed is:

1. A method of manufacturing a shelf-stable chlorophyll beverage, comprising:
forming a mixture by:
placing a quantity of water in a mixing tank,
adding Palmitate (Vitamin A), Cyanocobalamin (Vitamin B12), and Cholecalciferol (Vitamin D) to the mixing tank;
adding lemon juice to the mixing tank;
adding chlorophyll extract to the mixing tank;
transferring, from the mixing tank, the liquid to a bottling tank; and
filtering the mixture.

2. The method of claim 1, further comprising, after the filtering, placing the mixture into a filler.

3. The method of claim 2, further comprising packaging the mixture.

4. The method of claim 1, wherein the Vitamin A, Vitamin B12 and Vitamin D are added to the mixing tank while mixing simultaneously.

5. The method of claim 1, further comprising adding spearmint to the mixing tank.

6. The method of claim 1, wherein the beverage is formed of 99.7%-99.8% water by weight.

7. The method of claim 1, wherein the chlorophyll extract is copper chlorophyllin.

8. The method of claim 7, wherein the copper chlorophyllin 0.02%-0.03% of the beverage by weight.

9. The method of claim 1, wherein the beverage further comprises mint flavoring.

10. The method of claim 9, wherein the mint flavoring is 0.01%-0.03% by weight of the beverage.

11. The method of claim 1, further comprising 0.01%-0.4% by weight of a shelf stabilization agent.

12. The method of claim 11, wherein the shelf stabilization agent is a quantity of dimethyl dicarbonate (DMDC).

13. The method of claim 12, wherein the shelf stabilization agent is a quantity of MicroFresh.
